(19) United States
(12) Patent Application Publication
(10) Pub. No.: US 2019/0249804 A1
(43) Pub. Date: Aug. 15, 2019

(54) COUPLING NUT

(71) Applicant: Carrier Corporation, Palm Beach Gardens, FL (US)

(72) Inventor: Karl Fredrik Penden, Ashland, MA (US)

(21) Appl. No.: 16/342,878

(22) PCT Filed: Oct. 18, 2017
(86) PCT No.: PCT/US2017/057239

§ 371 Date: Apr. 17, 2019

Related U.S. Application Data
(60) Provisional application No. 62/409,823, filed on Oct. 18, 2016.

(51) Int. Cl. F16L 15/00

(52) U.S. Cl. CPC F16L 15/007

(57) ABSTRACT

A coupling nut (108) for joining a pair of conduits (104, 106) is provided. The coupling nut includes a first end (124) and a second end (126). An opening extends between the first end and the second end. The opening has an interior surface. A first coupling nut thread (114) extends along the interior surface at the first end and is constructed and arranged to receive a first conduit thread (110) having a first length (L1). A second coupling nut thread (116) extends along the interior surface at the second end and is constructed and arranged to receive a second conduit thread (112) having a second length (L2). A non-threaded central portion (118) extends between the first coupling nut thread and the second coupling nut thread. The non-threaded central portion (118) has a third length (L5). The third length (L5) of the non-threaded central portion is less than the sum of the first length (L1) of the first conduit thread and the second length (L2) of the second conduit thread.

### CROSS REFERENCE TO RELATED APPLICATION

The present application is an international patent application, which claims priority to U.S. Patent Application Ser. No. 62/409,823, filed Oct. 18, 2016, which is herein incorporated in its entirety.

### FIELD OF THE DISCLOSED EMBODIMENTS

The present embodiments generally relate to a coupling nut and, more particularly, a coupling nut for a system having pressurized fluid flowing therethrough.

### BACKGROUND OF THE EMBODIMENTS

Generally, systems that are configured to move pressurized fluid therethrough often include conduits that are coupled together. These conduits are required to be secured with a coupling nut so that the conduits do not separate under pressure. In some cases, the coupling nut used to join the conduits can be threaded leaving few threads engaged on one of the conduits. This can result in one of the conduits separating from the coupling nut under pressure.

A need remains for a coupling nut that prevents either of the conduits from being threaded too shallow into the coupling nut.

### SUMMARY OF THE EMBODIMENTS

In one aspect, a coupling nut for joining a pair of conduits is provided. The coupling nut includes a first end and a second end. An opening extends between the first end and the second end. The opening has an interior surface. A first coupling nut thread extends along the interior surface at the first end and is constructed and arranged to receive a first conduit thread having a first length. A second coupling nut thread extends along the interior surface at the second end and is constructed and arranged to receive a second conduit thread having a second length. A non-threaded central portion extends between the first coupling nut thread and the second coupling nut thread. The non-threaded central portion has a third length. The third length of the non-threaded central portion is less than the sum of the first length of the first conduit thread and the second length of the second conduit thread.

In one aspect, the third length is greater than the first length.

In one aspect, the third length is greater than the second length.

In one aspect, the first length is equal to the second length.

In one aspect, the first coupling nut thread is threaded in an opposite direction of the second coupling nut thread.

In one aspect, the first coupling nut thread comprises a right-hand thread, and the second coupling nut thread comprises a left-hand thread.

In one aspect, the first coupling nut thread comprises a left-hand thread, and the second coupling nut thread comprises a right-hand thread.

In one aspect, a system having pressurized fluid flowing therethrough is provided. The system includes a component having a first conduit. The component discharges pressurized fluid through the first conduit. The first conduit includes a first conduit thread having a first length. A second conduit includes a second conduit thread having a second length. A coupling nut is constructed and arranged to join the first conduit and the second conduit. The coupling nut includes a first end and a second end. An opening extends between the first end and the second end. The opening has an interior surface. A first coupling nut thread extends along the interior surface at the first end and is constructed and arranged to receive the first conduit thread. A second coupling nut thread extends along the interior surface at the second end and is constructed and arranged to receive the second conduit thread. A non-threaded central portion extends between the first coupling nut thread and the second coupling nut thread. The non-threaded central portion has a third length. The third length of the non-threaded central portion is less than the sum of the first length of the first conduit thread and the second length of the second conduit thread.

In one aspect, the third length is greater than the first length.

In one aspect, the third length is greater than the second length.

In one aspect, the first length is equal to the second length.

In one aspect, the first coupling nut thread is threaded in an opposite direction of the second coupling nut thread.

In one aspect, the first coupling nut thread comprises a right-hand thread, and the second coupling nut thread comprises a left-hand thread.

In one aspect, the first coupling nut thread comprises a left-hand thread, and the second coupling nut thread comprises a right-hand thread.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic view of a system in accordance with an embodiment.

FIG. 2 is a cross-sectional view of a coupling nut in accordance with an embodiment.

FIG. 3 is a cross-sectional view of a coupling nut in accordance with an embodiment.

FIG. 4 is a cross-sectional view of a coupling nut having a conduit coupled thereto in accordance with an embodiment.

FIG. 5 is a cross-sectional view of a coupling nut having a conduit coupled thereto in accordance with an embodiment.

### DETAILED DESCRIPTION OF THE EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

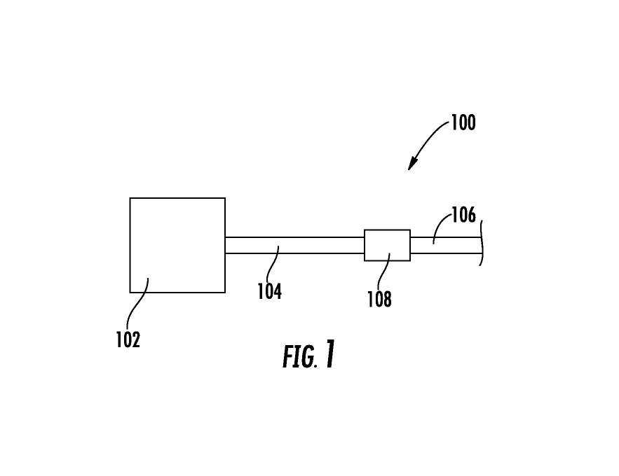

FIG. 1 illustrates a system 100 having pressurized fluid flowing therethrough. In one embodiment, the system 100 may be a fire suppression system 100. The system 100 includes at least one component 102 that is constructed and arranged to pressurize a fluid. For example, the component 102 may be a pump, a pressurized container, or the like. A first conduit 104 extends from the component 102. The first conduit 104 is coupled to a second conduit 106 via a coupling nut 108. The second conduit 106 may be coupled to another component of the system 100.

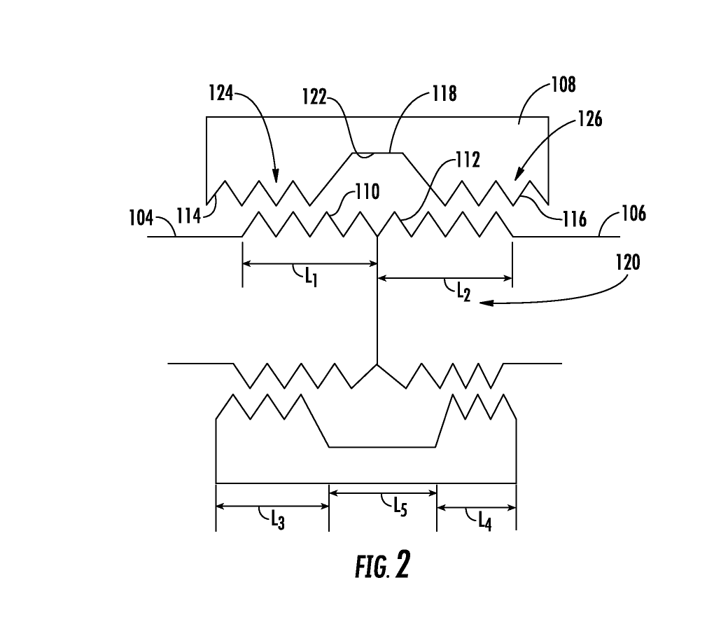

FIG. 2 illustrates the first conduit 104 coupled to the second conduit 106 via the coupling nut 108. The first conduit 104 includes a first conduit threaded end 110, and the second conduit 106 includes a second conduit threaded end 112. In one embodiment, the first conduit threaded end 110 may include a right-handed thread, and the second conduit threaded end 112 may include a left-handed thread. In one embodiment, the first conduit threaded end 110 may include a left-handed thread, and the second conduit threaded end 112 may include a right-handed thread. In one embodiment, both of the first conduit threaded end 110 and the second conduit threaded end 112 include the same threading, i.e. right-handed or left-handed. The first conduit threaded end 110 has a length L₁. The second conduit threaded end 112 has a length L₂. In one embodiment, the length L₁ is equal to the length L₂. In one embodiment, the length L₁ is not equal to the length L₂.

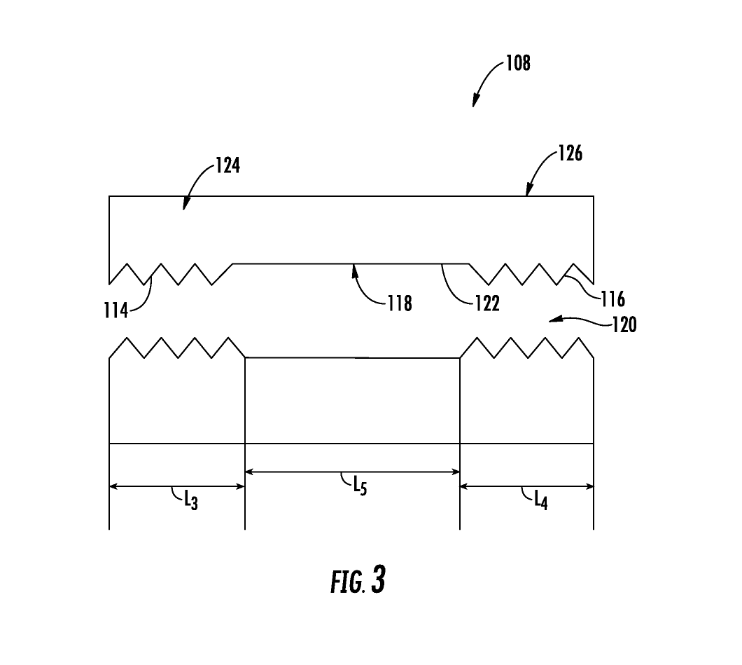

The coupling nut 108, illustrated in FIG. 3, includes a first end 124 and a second end 126. An opening 120 extends between the first end 124 and the second end 126 and has an interior surface 122. The coupling nut 108 includes a first threaded portion 114 and a second threaded portion 116. A non-threaded central portion 118 extends between the first threaded portion 114 and the second threaded portion 116. The first threaded portion 114 includes a thread on the interior surface 122 of the first end 124 that is configured either right-handed or left-handed to correspond to the thread of the first conduit threaded end 110. The second threaded end includes a thread on the interior surface 122 of the second end 126 that is configured either right-handed or left-handed to correspond to the thread of the second conduit threaded end 112. Accordingly, the first conduit 104 is configured to be coupled to the first threaded portion 114 of the coupling nut 108 to secure the first conduit 104 to the coupling nut 108. Also, the second conduit 106 is configured to be coupled to the second threaded portion 116 of the coupling nut 108 to secure the second conduit 106 to the coupling nut 108.

In one embodiment, the first threaded portion 114 of the coupling nut 108 has a length L₃, and the second threaded portion 116 of the coupling nut 108 has a length L₄. The non-threaded central portion 118 has a length L₅. In one embodiment, the length L₃ of the first threaded portion 114 of the coupling nut 108 is substantially equal to the length L₁ of the first conduit threaded end 110. In one embodiment, the length L₄ of the second threaded portion 116 of the coupling nut 108 is substantially equal to the length L₂ of the second conduit threaded end 112.

In one embodiment, the length L₁ of the first threaded portion 104 is less than the length L₅ of the non-threaded central portion 118, and the length L₂ of the second threaded portion 106 is less than the length L₅ of the non-threaded central portion 118. In one embodiment, the combined length of the length L₁ of the first threaded portion 104 and the length L₂ of the second threaded portion 106 is greater than the length L₅ of the non-threaded central portion 118.

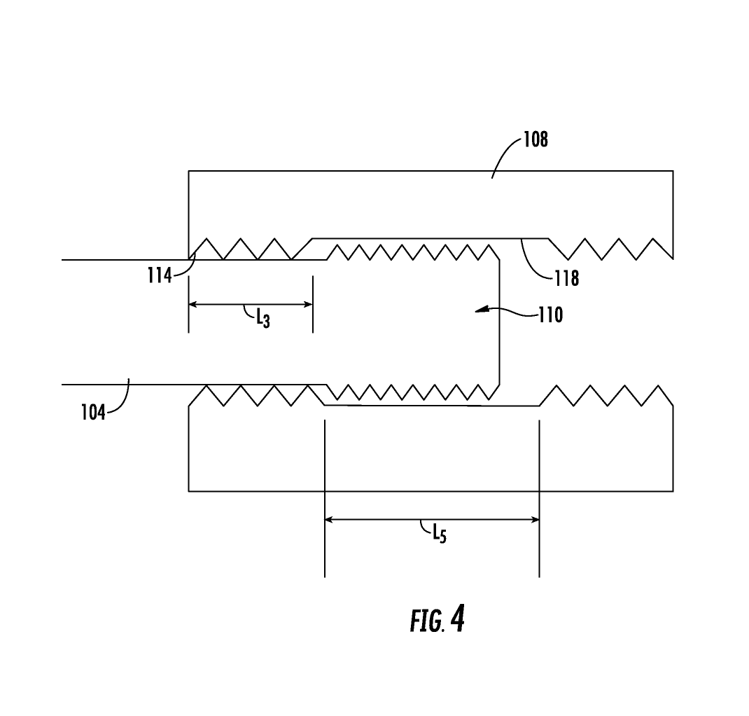

In one embodiment, as illustrated in FIG. 4, if the first conduit 104 is inserted into the coupling nut 108 too far, the first conduit threaded end 110 will become positioned within the non-threaded central portion 118 of the coupling nut 108 so that the first conduit 104 will rotate freely with respect to the coupling nut 108. This is due to the length L₅ of the non-threaded central portion 118 being greater than the length L₁ of the first threaded portion 110 of the first conduit 104.

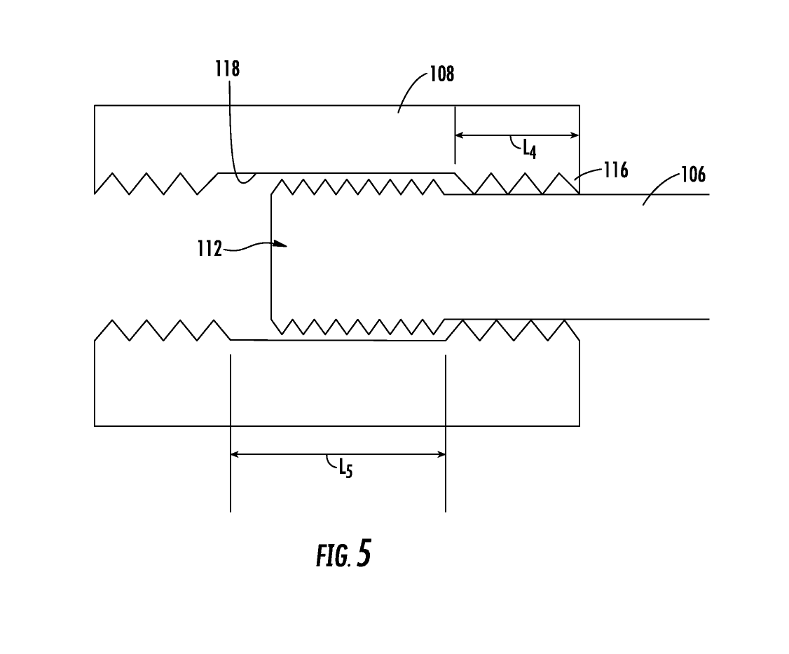

Moreover, in one embodiment, as illustrated in FIG. 5, if the second conduit 106 is inserted into the coupling nut 108 too far, the second conduit threaded end 112 will become positioned within the non-threaded central portion 118 of the coupling nut 108 so that the second conduit 106 will rotate freely with respect to the coupling nut 108. This is due to the length L₅ of the non-threaded central portion 118 being greater than the length L₂ of the threaded portion 112 of the second conduit 106.

However, because the length L₁ of the first threaded portion 110 of the first conduit 104 and the length L₂ of the threaded portion 106 of the second conduit 106 have a combined length that is greater than the length L₅ of the non-threaded central portion 118, the first conduit 104 and the second conduit 106 are incapable of both being inserted too far into the coupling nut 108. Accordingly, the first conduit 104 and the second conduit 106 can both be fully secured with the coupling nut 108 in an abutting configuration without either the first conduit 104 or the second conduit 106 being inserted too far into the coupling nut 108, as illustrated in FIG. 2. In one embodiment, if one of the first conduit 104 or the second conduit 106 is inserted too far into the coupling nut 108, the other of the first conduit 104 or the second conduit 106 will push the conduit that is inserted to far back into the respective threading of the coupling nut 108.

In one embodiment, a coupling nut is provided with left handed female threads on one side and right handed female threads on the other with a non-threaded portion in the center. The nut may be used to pull a male threaded hose and a male threaded reel together to form a tight face-seal near the center of the coupling. The length of the respective nut, hose and reel threads in relation to the non-threaded center of the nut is configured such that if either the hose or the reel male threads reach the center well before the mating part, it will disengage the thread and spin freely inside the nut until the mating component meets up to form the face seal.

Prior art configurations rely on the operator to gage that both mating parts have adequate thread engagement before forming a face seal. The embodiments described herein ensure geometrically that both mating parts always have adequate thread engagement when making the face seal. In the specific application of reel to hose connection, the hose doesn't risk disconnecting during an attempted fire extinguishing attempt.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A coupling nut for joining a pair of conduits comprising:
a first end;
a second end;
an opening extending between the first end and the second end, the opening having an interior surface;
a first coupling nut thread extending along the interior surface at the first end and constructed and arranged to receive a first conduit thread having a first length;
a second coupling nut thread extending along the interior surface at the second end and constructed and arranged to receive a second conduit thread having a second length; and
a non-threaded central portion extending between the first coupling nut thread and the second coupling nut thread, the non-threaded central portion having a third length, wherein the third length of the non-threaded central portion is less than the sum of the first length of the first conduit thread and the second length of the second conduit thread.

2. The coupling nut of claim 1, wherein the third length is greater than the first length.

3. The coupling nut of claim 1, wherein the third length is greater than the second length.

4. The coupling nut of claim 1, wherein the first length is equal to the second length.

5. The coupling nut of claim 1, wherein the first coupling nut thread is threaded in an opposite direction of the second coupling nut thread.

6. The coupling nut of claim 1, wherein:
the first coupling nut thread comprises a right-hand thread; and
the second coupling nut thread comprises a left-hand thread.

7. The coupling nut of claim 1, wherein:
the first coupling nut thread comprises a left-hand thread; and
the second coupling nut thread comprises a right-hand thread.

8. A system having pressurized fluid flowing therethrough comprising:
a component having a first conduit, wherein the component discharges pressurized fluid through the first conduit, wherein the first conduit comprises a first conduit thread having a first length;
a second conduit comprising a second conduit thread having a second length; and
a coupling nut constructed and arranged to join the first conduit and the second conduit, the coupling nut comprising:
a first end;
a second end;
an opening extending between the first end and the second end, the opening having an interior surface;
a first coupling nut thread extending along the interior surface at the first end and constructed and arranged to receive the first conduit thread;
a second coupling nut thread extending along the interior surface at the second end and constructed and arranged to receive the second conduit thread; and
a non-threaded central portion extending between the first coupling nut thread and the second coupling nut thread, the non-threaded central portion having a third length, wherein the third length of the non-threaded central portion is less than the sum of the first length of the first conduit thread and the second length of the second conduit thread.

9. The system claim 8, wherein the third length is greater than the first length.

10. The system claim 8, wherein the third length is greater than the second length.

11. The system claim 8, wherein the first length is equal to the second length.

12. The system claim 8, wherein the first coupling nut thread is threaded in an opposite direction of the second coupling nut thread.

13. The system claim 8, wherein:
the first coupling nut thread comprises a right-hand thread; and
the second coupling nut thread comprises a left-hand thread.

14. The system claim 8, wherein:
the first coupling nut thread comprises a left-hand thread; and
the second coupling nut thread comprises a right-hand thread.
